(19) United States
(12) Patent Application Publication
(10) Pub. No.: US 2024/0047798 A1
(43) Pub. Date: Feb. 8, 2024

(54) Battery Connecting Piece, Top Cover Assembly and Lithium Battery

(71) Applicant: JIANGSU ZENERGY BATTERY TECHNOLOGIES CO., LTD., Jiangsu (CN)

(72) Inventors: Tianshun WANG, Jiangsu (CN); Rui SUN, Jiangsu (CN); Yanlin HAN, Jiangsu (CN)

(21) Appl. No.: 18/230,462

(22) Filed: Aug. 4, 2023

(30) Foreign Application Priority Data
Aug. 4, 2022 (CN) 202222047807.3

(51) Int. Cl. H01M 50/169; H01M 10/052; H01M 50/503; H01M 50/536

(52) U.S. Cl. CPC H01M 50/169; H01M 10/052; H01M 50/503; H01M 50/536

(57) ABSTRACT

Disclosed are a battery connecting piece, a top cover assembly and a lithium battery. The battery connecting piece includes a first current collector and a second current collector, the first current collector is connected to the second current collector in a rotatable manner, the first current collector is configured to be connected to a top cover of a battery, the second current collector is configured to weld a tab of a cell, and an extension direction of a central axis of the second current collector rotating relative to the first current collector is perpendicular to a plane where the top cover is located in a state that the first current collector is connected to the top cover. The battery connecting piece drives the tab to fold more smoothly to prevent the tab from being torn, a bending precision of the tab is improved, and a product consistency is improved.

### CROSS-REFERENCE TO RELATED APPLICATION

The disclosure claims priority to and the benefit of Chinese Patent Application No. 202222047807.3, filed to the China National Intellectual Property Administration (CH IPA) on 4 Aug. 2022, which is hereby incorporated by reference in its entirety.

### TECHNICAL FIELD

The disclosure relates to the technical field of batteries, and in particular to a battery connecting piece, a top cover assembly, and a lithium battery.

### BACKGROUND

At present, different from common cells that having tabs lead out of the end surface, cells of some lithium batteries on the market that having tabs lead out of the side surface are affected by the lengths of the tabs, resulting in a serious waste of internal space of the case. In order to solve the problem of space waste, current collectors of some lithium batteries are bent after welding with the tabs, so as to drive the tabs to fold to an angle roughly parallel to the side surface of the cell.

Then, in the actual operation process, because the current collector is made of metal, there is a sudden change in stroke in the bending process, and the bending process is not smooth enough, often leading to the tear of the tabs, and the degree of bending of the current collector and the tab is difficult to accurately control, resulting in poor product consistency.

### SUMMARY

The purpose of the disclosure is to provide a battery connecting piece, a top cover assembly and a lithium battery, which drive a tab to fold more smoothly to prevent the tab from being torn, improve a bending precision of the tab, and improve a product consistency.

The disclosure provides a technical solution as follows.

Some embodiments of the disclosure provide a battery connecting piece, which includes a first current collector and a second current collector. The first current collector is connected to the second current collector in a rotatable manner, the first current collector is configured to be connected to a top cover of a battery, the second current collector is configured to weld a tab of a battery cell, and an extension direction of a central axis of the second current collector rotating relative to the first current collector is perpendicular to a plane where the top cover is located in a state that the first current collector is connected to the top cover.

In some embodiments, the second current collector is configured to rotate from a first state to a second state relative to the first current collector, in the first state, an included angle is formed between a plane where the second current collector and a plane where the first current collector is located, and in the second state, the plane where the second current collector is located is parallel to the plane where the first current collector is located.

In some embodiments, the first current collector is convexly provided with a bearing pedestal, the second current collector is convexly provided with a mating portion, the mating portion is embedded into the bearing pedestal, and the battery connecting piece further includes a rotating shaft, the rotating shaft penetrates through the mating portion and is matched with the bearing pedestal in a rotatable manner, and an extension direction of the rotating shaft is perpendicular to the plane where the top cover is located in a state that the first current collector is connected to the top cover.

In some embodiments, a radius of the rotating shaft is ranges from 1.8 mm to 4 mm;

a length of the rotating shaft ranges from 10 mm to 50 mm.

In some embodiments, the battery connecting piece further includes a spring, the spring is sleeved on the rotating shaft, one end of the spring abuts against a side of the mating portion away from the plastic member, and the other end of the spring abuts against the bearing pedestal.

Some other embodiments of the disclosure further provide a top cover assembly, including a top cover, a plastic member, and the battery connecting piece, the battery connecting piece includes the first current collector and the second current collector, the first current collector is connected to the second current collector in a rotatable manner, the first current collector is configured to be connected to the top cover of the battery, the second current collector is configured to weld the tab of the cell, and the extension direction of the central axis of the second current collector rotating relative to the first current collector is perpendicular to the plane where the top cover is located in a state that the first current collector is connected to the top cover. The top cover and the first current collector are respectively arranged on two opposite sides of the plastic member, the top cover is provided with a conductive block, and the first current collector is connected to the conductive block.

In some embodiments, a side of the plastic member away from the top cover is provided with a locking portion, and the locking portion is configured to lock the second current collector when the second current collector rotates to a second state.

In some embodiments, the locking portion protrudes from a surface of the plastic member, two opposite sides of the locking portion are provided with a guide surface and a stop surface respectively, a locking gap is formed between the stop surface and the first current collector, and the guide surface is configured to guide the second current collector over the locking portion and into the locking gap.

In some embodiments, the locking portion is a groove concavely arranged in a surface of the plastic member, and an extension direction of the groove is parallel to a plane where the first current collector is located.

Some still other embodiments of the disclosure further provide a lithium battery, including a cell and the top cover assembly. The top cover assembly includes the top cover, the plastic member, and the battery connecting piece. The battery connecting piece includes the first current collector and the second current collector. The first current collector is connected to the second current collector in a rotatable manner, the first current collector is configured to be connected to the top cover of the battery, the second current collector is configured to weld the tab of the cell, and the extension direction of the central axis of the second current collector rotating relative to the first current collector is perpendicular to the plane where the top cover is located when the first current collector is connected to the top cover. The top cover and the first current collector are respectively arranged on two opposite sides of the plastic member, the top cover is provided with the conductive block, and the first current collector is connected to the conductive block. The tab of the cell is welded with the second current collector.

Compared with the related art, according to the battery connecting piece provided by the disclosure, the second current collector is connected to the first current collector in a rotatable manner, the first current collector is configured to be connected to the conductive block on the top cover, and the second current collector is configured to weld the tab of the cell. In practical application, according to a plane where the tab is located, an angle of the second current collector relative to the first current collector is adjusted, so that the second current collector and the tab are attached in a face-to-face manner and welded, after the welding is completed, the second current collector is adjusted to rotate relative to the first current collector, so as to drive the tab to fold to a specific angle to avoid occupying too much space in a case. Because the second current collector is connected to the first current collector in a rotatable manner, so that a rotation process is smoother than a bending process of an existing current collector, an operation is convenient, and a rotation angle is easy to control. Therefore, the battery connecting piece provided by the disclosure has the beneficial effects that: driving the tab to fold more smoothly to prevent the tab from being torn, a bending precision of the tab is improved, and a product consistency is improved.

### BRIEF DESCRIPTION OF THE DRAWINGS

In order to more clearly illustrate the technical solutions in the embodiments of the disclosure, the drawings used in the embodiments will be briefly described below. It should be understood that the drawings below are only some embodiments of the disclosure and should not be regarded as a limitation of the scope. Other related drawings may further be obtained by those of ordinary skill in the art according to these drawings without creative efforts.

FIG. 1 is a structural schematic diagram of a top cover assembly according to Embodiment 1 of the disclosure.

FIG. 2 is a structural schematic diagram of a connection between a second current collector and a tab of a cell when the second current collector rotates to a first state in FIG. 1.

FIG. 3 is a structural schematic diagram of a connection between a second current collector and a tab of a cell when the second current collector rotates to a second state in FIG. 1.

FIG. 4 is an enlarged diagram of an area A in FIG. 2.

FIG. 5 is an enlarged diagram of an area B in FIG. 3.

FIG. 6 is a structural schematic diagram of a top cover assembly according to Embodiment 2 of the disclosure.

FIG. 7 is a structural schematic diagram of a connection between a second current collector and a tab of a battery cell when the second current collector rotates to a first state in FIG. 6.

FIG. 8 is a structural schematic diagram of a connection between a second current collector and a tab of a battery cell when the second current collector rotates to a second state in FIG. 6.

FIG. 9 is an enlarged diagram of an area C in FIG. 6.

FIG. 10 is an enlarged diagram of an area D in FIG. 7.

FIG. 11 is an enlarged diagram of an area E in FIG. 8.

Reference signs: 100—top cover assembly; 110—first current collector; 111—bearing pedestal; 120—second current collector; 121—mating portion; 130—plastic member; 131—locking portion; 1311—guide surface; 1312—stop surface; 132—locking gap; 140—top cover; 141—conductive block; 150—rotating shaft; 160—spring; 200—cell; 210—tab.

### DETAILED DESCRIPTION OF THE EMBODIMENTS

In order to make the purposes, technical solutions and advantages of the embodiments of the disclosure clearer, the technical solutions in the embodiments of the disclosure will be clearly and completely described below in combination with the drawings in the embodiments of the disclosure. It is apparent that the described embodiments are a part of the embodiments of the disclosure, and not all of them. Components of the embodiments of the disclosure generally described and illustrated in the drawings herein may be arranged and designed in a variety of different configurations.

Therefore, the following detailed description of the embodiments of the disclosure provided in the drawings is not intended to limit the scope of the claimed disclosure, but only represents the selected embodiments of the disclosure. All other embodiments obtained by those of ordinary skill in the art based on the embodiments of the disclosure without creative efforts are within the scope of protection of the disclosure.

It is to be noted that: similar reference signs and letters refer to similar items in the following drawings, so that once a certain item is defined in one drawing, it does not need to be further defined and explained in the subsequent drawings.

In the description of the disclosure, it is to be noted that the orientations or positional relationships indicated by the terms “upper”, “down”, “inside”, “outside”, “left”, “right”, etc. are based on the orientations or positional relationships shown in the drawings, or the orientations or positional relationships that are conventionally placed when the disclosure product is used, or the orientations or positional relationships that are conventionally understood by those skilled in the art, and are only for the convenience of describing the disclosure and simplifying the description. The description does not indicate or imply that the device or element referred to must have a specific orientation, be constructed and operated in a specific orientation, and therefore cannot be construed as limiting the disclosure.

In addition, the terms “first” and “second” are used for distinguishing the description only, and cannot be understood as indicating or implying relative importance.

In the description of the disclosure, it is also to be noted that, the terms “set”, “connect”, etc. should be broadly understood, unless otherwise specified and defined, for example, may be fixedly connected, or detachably connected, or integrally connected; may be mechanically connected, or electrically connected; and may be directly connected or indirectly connected through an intermediate medium, and may be the internal communication of two elements. The specific meaning of the above-mentioned terminology in the disclosure may be understood by those of ordinary skill in the art in specific circumstances.

The specific embodiments of the disclosure are elaborated in detail below with reference to the drawings.

### Embodiment 1

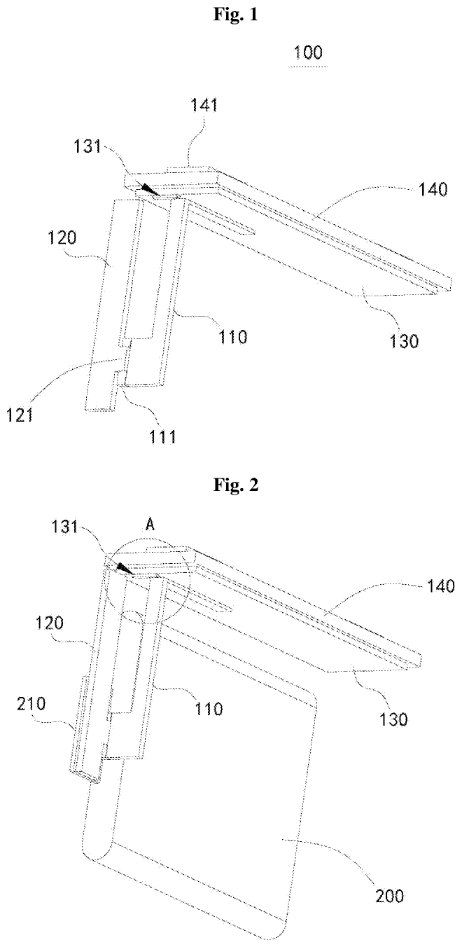

Referring to FIG. 1, FIG. 1 shows a structural schematic diagram of a top cover assembly 100 according to Embodiment 1.

A top cover assembly 100 provided by the embodiment includes a battery connecting piece, a plastic member 130, and a top cover 140. The battery connecting piece includes a first current collector 110 and a second current collector 120. The top cover 140 and the first current collector 110 are respectively arranged on two opposite sides of the plastic member 130, the top cover 140 is provided with a conductive block 141, the first current collector 110 is connected to the conductive block 141, the second current collector 120 is connected to the first current collector 110 in a rotatable manner, and the second current collector 120 is configured to weld a tab 210 of a cell 200.

Considering that in practical application, the top cover 140 covers a top end of a case, and in a case where the tab 210 is led out of a side surface of the cell 200, it is necessary to fold the tab 210 from a state extending perpendicular to the side surface of the cell 200 to a state parallel to the side surface of the cell 200 to save an internal space of the case. Therefore, in the embodiment, an extension direction of a central axis of the second current collector 120 rotating relative to the first current collector 110 is perpendicular to a plane where the plastic member 130 is located.

The second current collector 120 is configured to rotate from a first state to a second state relative to the first current collector 110, in the first state, an included angle is formed between a plane where the second current collector 120 is located and a plane where the first current collector 110 is located, and in the second state, the plane where the second current collector 120 is located is parallel to the plane where the first current collector 110 is located.

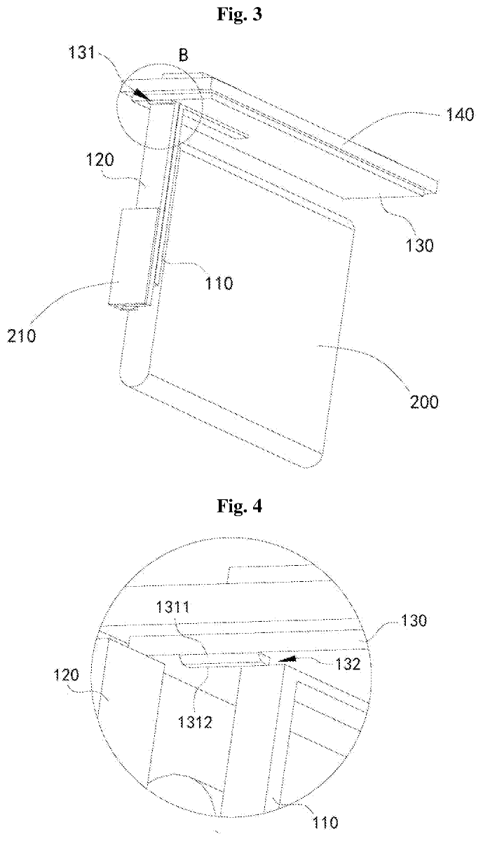

Referring to FIGS. 2-3, FIG. 2 shows a structural schematic diagram of a connection between the second current collector 120 and the tab 210 of the cell 200 when the second current collector 120 rotates to the first state relative to the first current collector 110, and FIG. 3 shows a structural schematic diagram of a connection between the second current collector 120 and the tab 210 of the cell 200 when the second current collector 120 rotates to the second state relative to the first current collector 110.

Actually, in the first state, the plane where the second current collector 120 is located is perpendicular to the plane where the first current collector 110 is located. In a case that the tab 210 is led out of the side surface, in the first state, the plane where the second current collector 120 is located is parallel to the plane where the tab 210 is located, that is, the second current collector 120 is actually perpendicular to the side surface of the cell 200 and the first current collector 110 is parallel to the side surface of the cell 200.

In the first state, the second current collector 120 is arranged face to face with the tab 210. At this time, the second current collector 120 and the tab 210 are attached and welded together. Because the second current collector 120 is perpendicular to the side surface of the cell 200, a large space between the side surface of the cell 200 and an inner side wall of the case is occupied. In order to reduce a space occupation, the second current collector 120 is driven to rotate to the second state relative to the first current collector 110.

When the second current collector 120 drives the tab 210 to rotate to the second state, the second current collector 120 is parallel to the first current collector 110. At this time, all of the second current collector 120, the first current collector 110 and the tab 210 are parallel to the side surface of the cell 200 and an inner side wall of the case. In this state, a width of space occupied between the side surface of the tab 210 and the inner side wall of the case is only a sum of thicknesses of the first current collector 110, the second current collector 120, and the tab 210. Compared with the first state, a space occupancy rate is greatly reduced.

Because the second current collector 120 is matched with the first current collector 110 in a rotatable manner, a process of driving the tab 210 to rotate relative to the first current collector 110 by the second current collector 120 is smoothly performed, which prevents a sudden change in stroke and protects the tab 210 from being torn.

Compared with bending of the current collector to a specific angle, a rotation of the second current collector 120 to a specific angle relative to the first current collector 110 is easier to realize and easy to adjust, that is, the second current collector 120 is able to rotate more accurately to the specific angle, which significantly improves a product consistency during a mass production process.

In the embodiment, the battery connecting piece further includes a rotating shaft 150. The second current collector 120 is matched with the first current collector 110 in a rotatable manner by the rotating shaft 150. Actually, the first current collector 110 is convexly provided with a bearing pedestal 111, the second current collector 120 is convexly provided with a mating portion 121, the mating portion 121 is embedded into the bearing pedestal 111, the rotating shaft 150 penetrates through the mating portion 121 and is matched with the bearing pedestal 111 in a rotatable manner, and an extension direction of the rotating shaft 150 is perpendicular to a plane where the plastic member 130 is located.

It is understandable that, in other embodiments, arrangement positions of the bearing pedestal 111 and the mating portion 121 are also exchangeable, that is, the bearing pedestal 111 is arranged on the second current collector 120, the mating portion 121 is arranged on the first current collector 110, and the mating portion 121 is also matched with the bearing pedestal 111 in a rotatable manner by the rotating shaft 150.

In other embodiments, the first current collector 110 is rotatably matched with the second current collector 120 in a smoother rotatably matched manner in other rotation processes.

In the embodiment, the rotating shaft 150 is an independent component. In order to meet a current passing requirement, a radius of the rotating shaft 150 ranges from 1.8 mm to 4 mm. If the radius exceeds 4 mm, the overflowing requirement exceeds the standard, which excessively increases a weight of the overall structure, and is not conducive to the rotation of the second current collector 120. If the radius is less than 1.8 mm, the current passing requirement will be not met. Moreover, a length of the rotating shaft 150 is between and 50 mm, if less than 10 mm, the strength is not enough, and if more than 50 mm, the overall weight is too large.

In other embodiments, the rotating shaft 150 is also integrated with the mating portion 121, that is, the rotating shaft 150 is part of a body of the second current collector 120, so as to avoid a gap with the inner side wall of the mating portion 121 when the rotating shaft 150 penetrates through the mating portion 121, resulting in a sudden change in stroke during the rotation process.

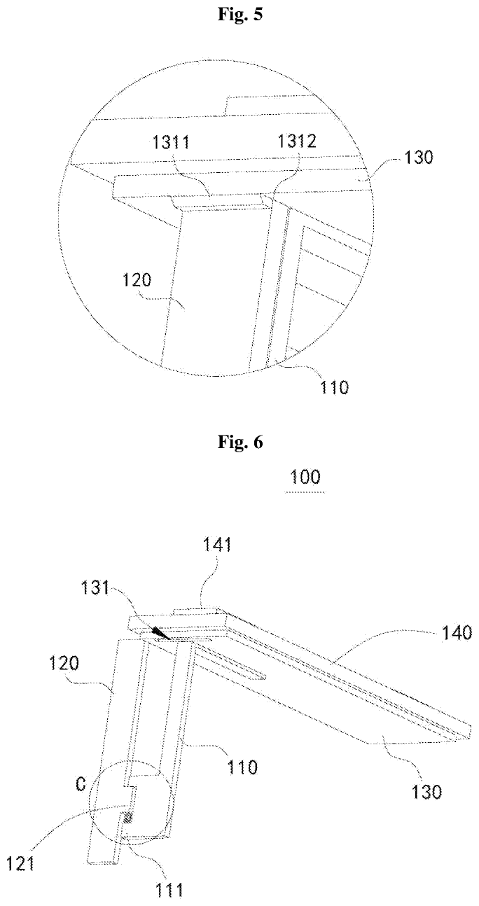

Referring to FIGS. 4-5, FIG. 4 shows an enlarged diagram of an area A in FIG. 2, and FIG. 5 shows an enlarged diagram of an area B in FIG. 3.

In order to ensure a precise rotation of the second current collector 120, the side of the plastic member 130 away from the top cover 140 is provided with a locking portion 131, and the locking portion 131 is configured to lock the second current collector 120 when the second current collector 120 rotates from the first state to the second state.

In the embodiment, the locking portion 131 protrudes from a surface of the plastic member 130, two opposite sides of the locking portion 131 are provided with a guide surface 1311 and a stop surface 1312 respectively, a locking gap 132 is formed between the stop surface 1312 and the first current collector 110, and the guide surface 1311 is configured to guide the second current collector 120 over the locking portion 131 and into the locking gap 132.

In practical application, by prearranging a relative positional relationship between the second current collector 120 and the locking portion 131 in a vertical direction, it is ensured that the guide surface 1311 of the locking portion 131 stops a rotation stroke of the second current collector 120 rotating from the first state to the second state. When the second current collector 120 rotates at a certain angle, the end of the second current collector 120 close to the plastic member 130 is in contact with the guide surface 1311, and the guide surface 1311 is an inclined plane structure, the second current collector 120 has a certain elastic deformation ability, and as the second current collector 120 continues rotating, the second current collector 120 slides on the guide surface 1311.

When the second current collector 120 is embedded into the locking gap 132 over the locking portion 131 under a guidance of the guide surface 1311, the second current collector 120 just rotates to the second state, and a plane where the stop surface 1312 is located and a plane where the first current collector 110 is located are both perpendicular to the plane where the plastic member 130 is located. At this time, the stop surface 1312 and the first current collector 110 realize a positioning locking on the second current collector 120.

### Embodiment 2

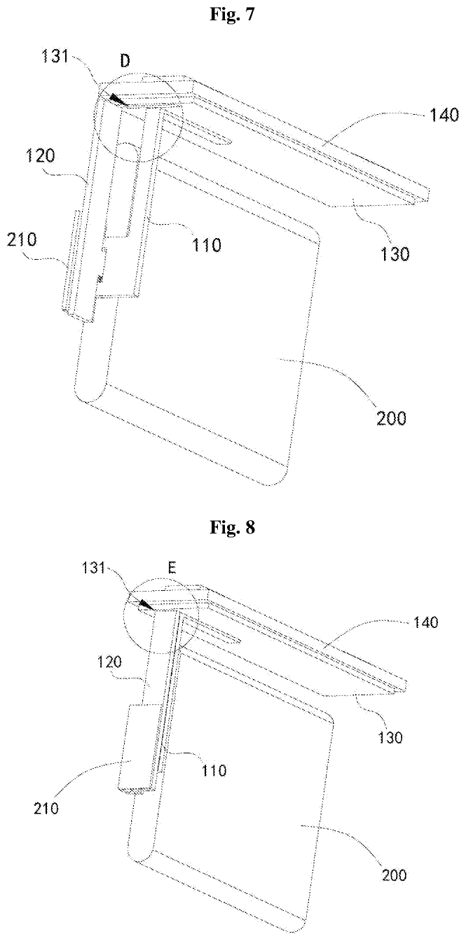

Referring to FIGS. 6-8, FIG. 6 shows a structural schematic diagram of a top cover assembly 100 according to Embodiment 2, FIG. 7 shows a structural schematic diagram of a connection between a second current collector 120 and a tab 210 of a cell 200 when the second current collector 120 is in a first state, and FIG. 8 shows a structural schematic diagram of a connection between the second current collector 120 and the tab 210 of the cell 200 when the second current collector 120 is in a second state.

The top cover assembly 100 provided by the embodiment differs from Embodiment 1 in a structure of a locking portion 131 and the fact that the top cover assembly 100 in the embodiment further includes a spring 160, and the rest of the features are exactly the same as those in Embodiment 1.

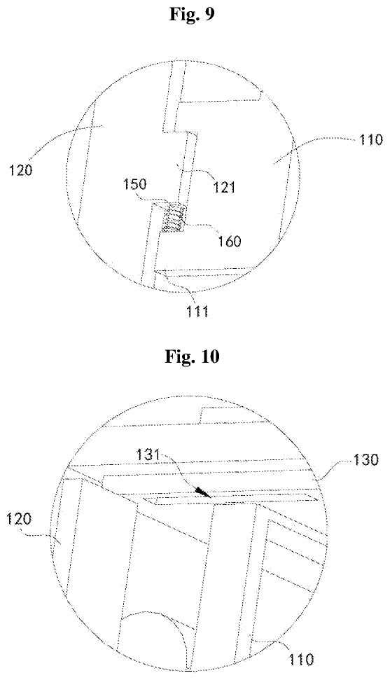

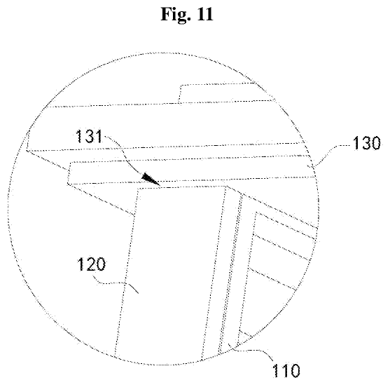

Referring to FIGS. 9-11, FIG. 9 shows an enlarged diagram of an area C in FIG. 6, and FIG. 10 shows an enlarged diagram of an area D in FIG. 7. FIG. 11 shows an enlarged diagram of an area E in FIG. 8.

As in Embodiment 1, in the embodiment, the first current collector 110 is convexly provided with the bearing pedestal 111, the second current collector 120 is convexly provided with the mating portion 121, the mating portion 121 is embedded into the bearing pedestal 111, the rotating shaft 150 penetrates through the mating portion 121 and is matched with the bearing pedestal 111 in a rotatable manner, and an extension direction of the rotating shaft 150 is perpendicular to a plane where the plastic member 130 is located.

The embodiment differs from Embodiment 1 in that the locking portion 131 is a groove concavely arranged in the surface of the plastic member 130, and the top cover assembly 100 further includes the spring 160. The spring 160 is sleeved on the rotating shaft 150, one end of the spring 160 abuts against a side of the mating portion 121 away from the plastic member 130, and the other end of the spring 160 abuts against the bearing pedestal 111. The spring 160 is configured to push the second current collector 120 to be embedded into the groove when the second current collector 120 rotates to the second state.

Actually, in the state shown in FIG. 6, the second current collector 120 rotates out of a range of the plastic member 130. At this time, the spring 160 extends to a maximum stroke to push the second current collector 120 beyond the lower surface of the plastic member 130. In a process of rotating the second current collector 120 from the state shown in FIG. 6 to the first state shown in FIG. 7, an external force is applied to the second current collector 120, so that the second current collector 120 extrudes the spring 160, and the end wall of the second current collector 120 is slightly lower than the lower surface of the plastic member 130 to ensure that the second current collector 120 smoothly rotates to the first state without being blocked by the plastic member 130.

In the first state, the second current collector 120 is continuously pressed by the plastic member 130, that is, the spring 160 is kept in a compressed state. In this state, the second current collector 120 and the tab 210 of the cell 200 are attached in a face-to-face manner and welded, and after welding, the second current collector 120 is pushed to rotate to the second state. The locking portion 131 as the groove is just arranged at a position when the second current collector 120 is in the second state. When the second current collector 120 rotates to the second state, one end of the second current collector 120 abutting against the plastic member 130 is embedded into the groove under the vertical upward thrust applied by the spring 160, and the groove realizes an accurate positioning of the plastic member 130.

In order to minimize a space occupancy rate in the second state, in the embodiment, the extension direction of the groove is parallel to the plane where the first current collector 110 is located, and a width size of the groove corresponds to that of the second current collector 120, so as to ensure that the second current collector 120 is just parallel to the first current collector 110 when the second current collector 120 is embedded into the groove, that is, parallel to a side surface of the cell 200 and an inner side wall of the case.

It is to be noted that rotatable matched manners of the second current collector 120 and the first current collector 110 and a specific structure of the locking portion 131 are not limited to the records of Embodiment 1 and Embodiment 2 of the disclosure, and are adaptively adjusted according to the actual application conditions.

In summary, according to the top cover assembly 100 provided by the disclosure, the tab 210 is driven to fold more smoothly, the tab 210 is prevented from being torn, the bending precision of the tab 210 is improved, and the product consistency is improved.

In addition, some embodiments also provide a lithium battery, including the cell 200 and the top cover assembly 100 corresponding to any one of the above two embodiments. The tab 210 of the cell 200 is welded with the second current collector 120. It is understandable that the lithium battery further includes conventional structures such as the case, an upper plastic member, etc., which are not additionally described in the embodiment.

Because the second current collector 120 is matched with the first current collector 110 in a rotatable manner, the process of driving the tab 210 to rotate relative to the first current collector 110 by the second current collector 120 is smoothly performed, which prevents a sudden change in stroke and protects the tab 210 from being torn. Moreover, compared with bending of the current collector to a specific angle, the rotation of the second current collector 120 to a specific angle relative to the first current collector 110 is easier to realize and easy to adjust, that is, the second current collector 120 rotates more accurately to a specific angle, which significantly improves the product consistency in the mass production process.

Therefore, the lithium battery provided by the embodiment prevents the tab 210 from being torn during the production process, the bending precision of the tab 210 is high, and the product consistency is high.

The above are only the specific embodiments of the disclosure and are not intended to limit the disclosure. For those skilled in the art, the disclosure may have various modifications and variations. Any modifications, equivalent substitutions, improvements, etc. within the spirit and scope of the disclosure shall fall within the scope of protection of the disclosure.

What is claimed is:

1. A battery connecting piece, comprising a first current collector and a second current collector, the first current collector is connected to the second current collector in a rotatable manner, the first current collector is configured to be connected to a top cover of a battery, the second current collector is configured to weld a tab of a cell, and an extension direction of a central axis of the second current collector rotating relative to the first current collector is perpendicular to a plane where the top cover is located in a state that the first current collector is connected to the top cover.

2. The battery connecting piece according to claim 1, wherein the second current collector is configured to rotate from a first state to a second state relative to the first current collector, in the first state, an included angle is formed between a plane where the second current collector and a plane where the first current collector is located, and in the second state, the plane where the second current collector is located is parallel to the plane where the first current collector is located.

3. The battery connecting piece according to claim 1, wherein the first current collector is convexly provided with a bearing pedestal, the second current collector is convexly provided with a mating portion, the mating portion is embedded into the bearing pedestal, and the battery connecting piece further comprises a rotating shaft, and the rotating shaft penetrates through the mating portion and is matched with the bearing pedestal in a rotatable manner, and an extension direction of the rotating shaft is perpendicular to the plane where the top cover is located in a state that the first current collector is connected to the top cover.

4. The battery connecting piece according to claim 3, wherein
the radius of the rotating shaft ranges from 1.8 mm to 4 mm; and
the length of the rotating shaft ranges from 10 mm to 50 mm.

5. The battery connecting piece according to claim 3, wherein the battery connecting piece further comprises a spring, and the spring is sleeved on the rotating shaft, one end of the spring abuts against a side of the mating portion away from the top cover, and the other end of the spring abuts against the bearing pedestal.

6. A top cover assembly, comprising a top cover, a plastic member, and the battery connecting piece according to claim 1, the top cover and the first current collector are respectively arranged on two opposite sides of the plastic member, the top cover is provided with a conductive block, and the first current collector is connected to the conductive block.

7. The top cover assembly according to claim 6, wherein a side of the plastic member away from the top cover is provided with a locking portion, and the locking portion is configured to lock the second current collector when the second current collector rotates to a second state.

8. The top cover assembly according to claim 7, wherein the locking portion protrudes from a surface of the plastic member, two opposite sides of the locking portion are provided with a guide surface and a stop surface respectively, a locking gap is formed between the stop surface and the first current collector, and the guide surface is configured to guide the second current collector over the locking portion and into the locking gap.

9. The top cover assembly according to claim 7, wherein the locking portion is a groove concavely arranged in a surface of the plastic member, and an extension direction of the groove is parallel to a plane where the first current collector is located.

10. The top cover assembly according to claim 6, wherein the second current collector is configured to rotate from a first state to a second state relative to the first current collector, in the first state, an included angle is formed between a plane where the second current collector and a plane where the first current collector is located, and in the second state, the plane where the second current collector is located is parallel to the plane where the first current collector is located.

11. The top cover assembly according to claim 6, wherein the first current collector is convexly provided with a bearing pedestal, the second current collector is convexly provided with a mating portion, the mating portion is embedded into the bearing pedestal, and the battery connecting piece further comprises a rotating shaft, and the rotating shaft penetrates through the mating portion and is matched with the bearing pedestal in a rotatable manner, and an extension direction of the rotating shaft is perpendicular to the plane where the top cover is located in a state that the first current collector is connected to the top cover.

12. The top cover assembly according to claim 11, wherein
the radius of the rotating shaft ranges from 1.8 mm to 4 mm; and
the length of the rotating shaft ranges from 10 mm to 50 mm.

13. The top cover assembly according to claim 11, wherein the battery connecting piece further comprises a spring, and the spring is sleeved on the rotating shaft, one end of the spring abuts against a side of the mating portion away from the top cover, and the other end of the spring abuts against the bearing pedestal.

14. A lithium battery, comprising a cell and the top cover assembly according to claim 6, a tab of the cell is welded with the second current collector.

15. The lithium battery according to claim 14, wherein a side of the plastic member away from the top cover is provided with a locking portion, and the locking portion is configured to lock the second current collector of the battery connecting piece when the second current collector rotates to a second state.

16. The lithium battery according to claim 15, wherein the locking portion protrudes from a surface of the plastic member, two opposite sides of the locking portion are provided with a guide surface and a stop surface respectively, a locking gap is formed between the stop surface and the first current collector, and the guide surface is configured to guide the second current collector over the locking portion and into the locking gap.

17. The lithium battery according to claim 15, wherein the locking portion is a groove concavely arranged in a surface of the plastic member, and an extension direction of the groove is parallel to a plane where the first current collector is located.

18. The lithium battery according to claim 14, wherein the second current collector is configured to rotate from a first state to a second state relative to the first current collector, in the first state, an included angle is formed between a plane where the second current collector and a plane where the first current collector is located, and in the second state, the plane where the second current collector is located is parallel to the plane where the first current collector is located.

19. The lithium battery according to claim 18, wherein the first current collector is convexly provided with a bearing pedestal, the second current collector is convexly provided with a mating portion, the mating portion is embedded into the bearing pedestal, and the battery connecting piece further comprises a rotating shaft, and the rotating shaft penetrates through the mating portion and is matched with the bearing pedestal in a rotatable manner, and an extension direction of the rotating shaft is perpendicular to the plane where the top cover is located in a state that the first current collector is connected to the top cover.

20. The lithium battery according to claim 18, wherein the battery connecting piece further comprises a spring, and the spring is sleeved on the rotating shaft, one end of the spring abuts against a side of the mating portion away from the top cover, and the other end of the spring abuts against the bearing pedestal.
